(19) United States
(12) Patent Application Publication
(10) Pub. No.: US 2004/0030787 A1
(43) Pub. Date: Feb. 12, 2004

(54) Communication infrastructure arrangement for multiuser

(76) Inventors: Magnus Jandel, Upplands (SE); Martin Stenhoff, Spanga (SE); Roland Karlsson, Stockholm (SE)

Correspondence Address: YOUNG & THOMPSON, 745 SOUTH 23RD STREET 2ND FLOOR, ARLINGTON, VA, 22202

(21) Appl. No.: 10/415,271

(22) PCT Filed: Oct. 22, 2001
(86) PCT No.: PCT/SE01/02309

(30) Foreign Application Priority Data
Oct. 27, 2000 (SE) 0003927-1

(51) Int. Cl. G06F 15/16

(52) U.S. Cl. 709/229

(57) ABSTRACT

This invention relates to a communication infrastructure arrangement in and a computer readable program product for a data processing system for multi-user applications, i.e. applications for multiple clients, enabling simultaneous communication across an application communication network (1) between several clients joined in at least one client group (CG). At least one distributed multi-user application is provided on the application communication network (1). Each multi-user application has nodes (AC, ASNS, ACG, AR, AS, APDB, ALS, ANMS, CAS, CGH) and databases (11, DB1, APDB) for handling each client group (CG). A set of attributes (7, 8, CGDB) for each client group (CG) determines the function and usage of the client group. At least one session (13) is provided, in which the attributes are listed. The selection of attributes is made to fit the intended function of the client group (CG) and the capabilities of the application communication network (1).

This invention relates essentially to a communication infrastructure arrangement according to the preamble of claim 1.

### TECHNICAL FIELD OF THE INVENTION

The application for the invention is networked virtual environments where widely distributed, multiple users interact in real-time. An application is here defined as a distributed computer process that is processing a networked virtual environment. Such applications aim for a sense of realism and an intensified (immersed) experience in a virtual world. They are used for military and industrial team training, collaborative design and engineering, multi-player games, virtual shopping, virtual conferences, remote customer support and distance learning. The application session is terminated under some predefined conditions.

A distributed computer process that is processing a networked virtual environment is in the following called an application.

An Application Session is an instance of an application that is started at a given point in time, clients join and leave the virtual world and the application session is eventually terminated under some predefined conditions.

There are some co-pending applications to this application. One of them is PCT/SE00/00932 “Application Access Server” having the priority date 1999-05-10 from both SE 9901694-1 and U.S. Ser. No. 09/307,712.

Simultaneously with this application are the co-pending applications SE- . . . Profiles) “Automatic configuration of a flexible communication infrastructure for MULTI-USER”applications and SE- . . . Name Server “Name service for networked MULTI-USER applications”.

Some of the elements shown and discussed in this application are discussed in more detail in the co-pending applications. Some of the elements shown and discussed in this application are discussed in more detail in the co-pending applications, which are hereby incorporated by reference in its entirety for all and any purposes.

Regarding the expression IP multicast See appendix at the end of the specification.

### DESCRIPTION OF RELATED ART

PCT/SE00/00932 is a co-pending application, which describes a real-time performance in a communication network between a large number of participants. A server unit is provided comprising receiving means for receiving information from the client units. The server unit stores state information received from each of the client units and forwards this information to nodes in the network. It also transmits at least a part of the stored information to the clients. In this way the whole state of an application can be kept in one or more units in the network. This removes the need for each client to store the entire state, thereby reducing memory and bandwidth requirement for each client.

The DirectPlay Application Programming Interface from Microsoft uses the concept of hierarchical player groups. Some of the concepts in this proposal are published in an article DirectPlay) B. Bargen and P. Donnelly, “Inside DirectX”, Microsoft Press 1998. This reference describes, however, only an application program interface, below called API, and not a complete application network.

http://www.gamasutra.com/features/20000621/aronson_{—}01.htm is an article by Jesse Aronson, “Using Grouping for Network Gaming” published on the INTERNET on Jun. 21, 2000, regarding the use of client groups in multi-player games.

### OBJECTS OF THE INVENTION

A client group is a set of clients that is registered as a group in an application network.

An object of the invention is to provide a communication infrastructure for effective multicasting of application data including simultaneous distribution of identical data to a well-defined group of clients.

Another object of the invention is to provide a communication infrastructure, which can ease authorization of client groups and individual clients in client groups.

Another object of the invention is to provide a communication infrastructure for Security, i.e. controlling the access to application data by private communication to client groups.

Yet another object of the invention is to provide a communication infrastructure for creating and managing persistent logical roles in the application that owns application data and application data streams. A client group could be a pseudo client that owns and controls game data but doesn't correspond to a real client machine or a human player.

Still another object of the invention is to provide a communication infrastructure for creating and managing shared application data and application data streams with a controlled collective ownership.

Another object of the invention is to provide a communication infrastructure for distributing information about the state of the members of a client group.

### SUMMARY OF THE INVENTION

The invention is intended to use client groups in a distributed multi-user application on an application communication network that has nodes and databases for handling client groups.

Client Group Attributes

A client group (CG) can have a set of attributes that determines the functions and usage of the client group. The attributes are listed in this section. Each attribute may be set independently of the other attributes. The selection of attributes is made to fit the intended function of the client group CG and the capabilities of the application network. The attributes are: Receiver, Source, Membership protection mode, Event distribution mode, Name and Alias, Distribution mode, Termination conditions; Client profile, Parents, Ancestors, Children, Descendants.

Receiver

A receiver client group is used for distributing identical data to all members of the client group. A receiver client group has an associated network address (e.g. an IP multicast) or an application address. A client group or client address is either a network address or an application address. A sender that knows the address could transmit data to all members of the group.

Source

A source client group is the owner or the source of application data units. The client group acts as the sender of the data unit. A pseudo client is a source client group with one or several active members using the client group as an alias for example for providing a persistent service to the session. A pseudo client could also have passive members, who do not participate in secondary data. A passive member could become active, for example when an active client leave.

Membership Protection Mode

The right to become a member and/or to leave of a client group could be protected by a security system where only authorized clients are accepted as members. The membership protection mode is then closed. Alternatively, it could be free for all clients to join and leave, as they like. The membership protection mode is then open. There could be more than these two modes.

Event Distribution Mode

The members of the client group could get information about all group events such as clients joining, clients leaving, data units created and deleted, data subscriptions etc. The event distribution mode is then Verbose. Alternatively the members could get no such information. The event distribution mode is then Silent.

Name and Alias

A network address or an application address could identify a client group. A client group could also have a name that is known by the application and optionally stored in an application session name server or in the CGH as described below. A client group could also have one or several alternative names called aliases. Any means for identifying the client group including those mentioned here are called a client group identifier.

Distribution Mode

Consider a sender that is transmitting a data unit to a client group using a client group identifier for addressing. The method for sending the data unit to the members of the client group is called the client group distribution mode. Possible distribution modes are:

1) Unicast, where the sender retrieves a list of individual addresses to the members of the group and sends one copy of the data unit to each member.

2) Broadcast where the sender transmits the data unit to all participants in the session with a tag that indicates that the data unit is intended only for the members of the client group. All members of the client group receive the data unit. IP and LAN broadcast belongs to this category.,

3) IP multicast where the client group is associated with an IP multicast address. IP multicast is described in the Appendix at the end of this Specification.

4) Application multicast where the application network described below provides a multicast function at the application level. The sending client sends one copy of the data unit to an application router. The data unit has a tag, which identifies the client group. This tag is an application address to the client group. The system of application routers transmits the data unit across the application network and makes copies as needed. All members of the client group receive the data unit.

5) Central server multicast where an application content server receives one copy of the data unit from the sending client and distributes one copy of the data unit to all members of the client group.

Client Profile

A client profile consisting of a set of application network parameters is prepared and stored before the client group is created. The client profile is not a part of this invention and is described in more detail in a co-pending application SE- . . . {Profiles}. The client profile is used to initialize and prepare the programmable application network and the client computer before a given client group joins the multi-user application session. A user that wishes to create a client group negotiates the use of a certain client profile with the service provider.

Children

A client group could be a member of other client groups. The set of clients and client groups that are members of a client group is called the children of client group C.

Descendants

The children of a client group C could also have other client groups as members. This creates a hierarchy of client groups with C as the top node. The set of all client groups that are either a member of C or a member of a member or occurs anywhere below C in the hierarchy is called the descendants of C.

Parents

A client group could be a member of other client groups. The set of client groups that has a given client group C as a member is called the parents of client group C.

Ancestors

The set of all client groups that has a given client group C as a descendant is called the ancestors of C.

### BRIEF DESCRIPTION OF DRAWINGS

For a more complete understanding of the present invention and for further objects and advantages thereof, reference is now made to the following description of an embodiment thereof—as shown in the accompanying drawings.

FIG. 1 illustrates a programmable application network (PAN) suitable for supporting networked virtual environments for the invention;

FIGS. 2A to 2C are flow diagrams illustrating the operation of the invention;

FIG. 3 illustrates a possible implementation of a client group handler (CGH); and

FIG. 4 illustrates IP multicasting, where arrows show data paths and relates to the Appendix.

### DETAILED DESCRIPTION OF A PREFERRED EMBODIMENT

Application Network (AN) 1

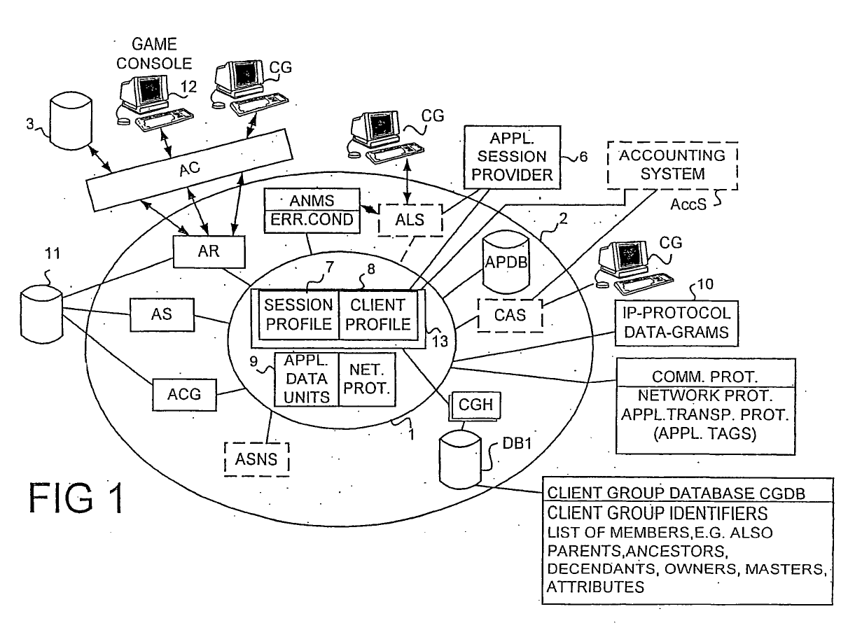

Referring to FIG. 1, an application network 1 is suitable for supporting networked virtual environments. The application network 1 comprises a communication network 2, which includes communication links and routers for general-purpose communication protocols, such as Internet protocols. The application network 1 includes also several nodes, such as AC, ASNS, ACG, AR, AS, APDB, ALS, ANMS, CAS, CGH, dedicated for supporting an application session 13. Not all of these nodes must be present in a given application session 13. Several instances of a given node type may be present.

The application network 1 can be programmed or configured to support a given application session 13 and a given set of clients by setting the application network parameters so that sufficient bandwidth, network addresses, server memory, server computing power, application content generator capacity, application session name server capacity etc are allocated.

The nodes of a programmable application network 1 are described below.

Client Group Handler (CGH)

There could be at least one, preferably several, client group handler CGH, which is a particular means for this invention. The client group handler CGH comprises a database DB1 containing data about client groups. The data includes for each client group the list of members, and, a list of the attributes of the client group. The database DB1 could also comprise a list of invited members (see below), a list of client group owners (see below), and possibly also other data.

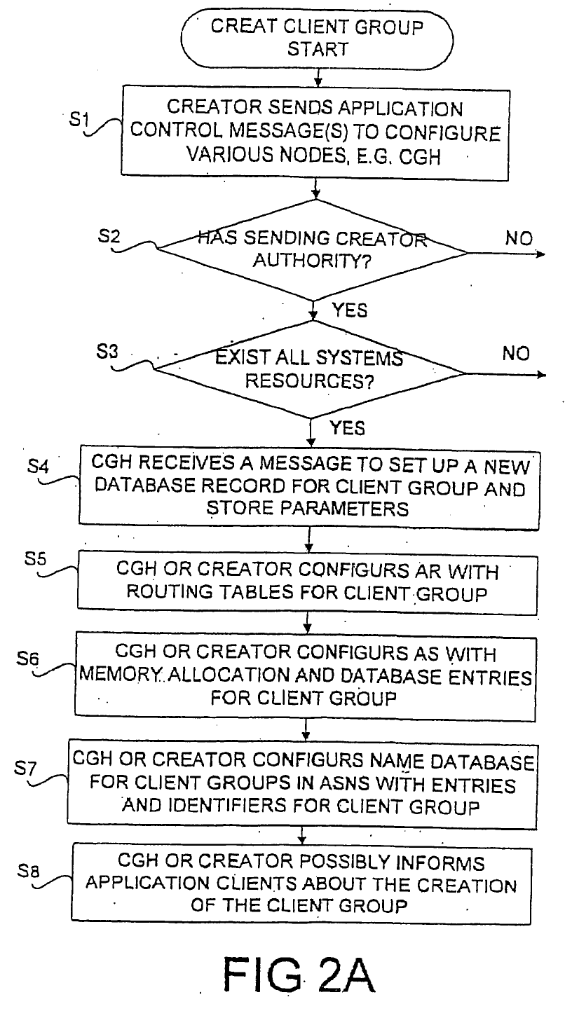

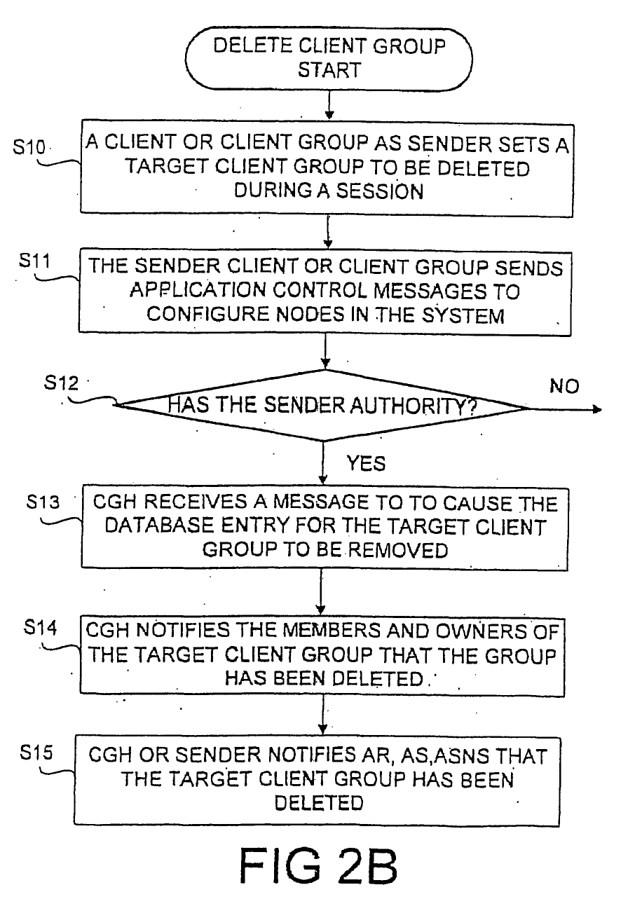

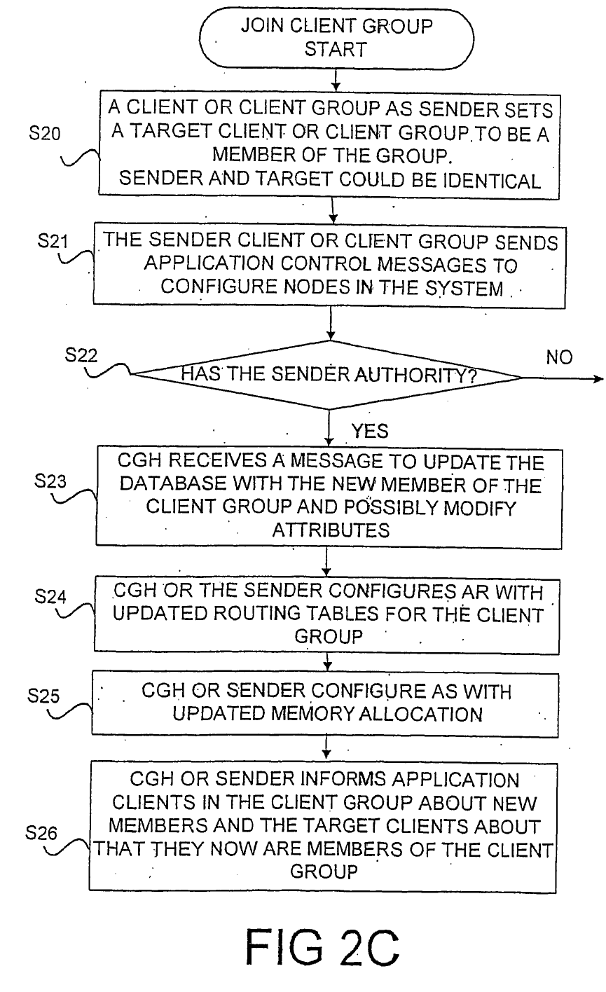

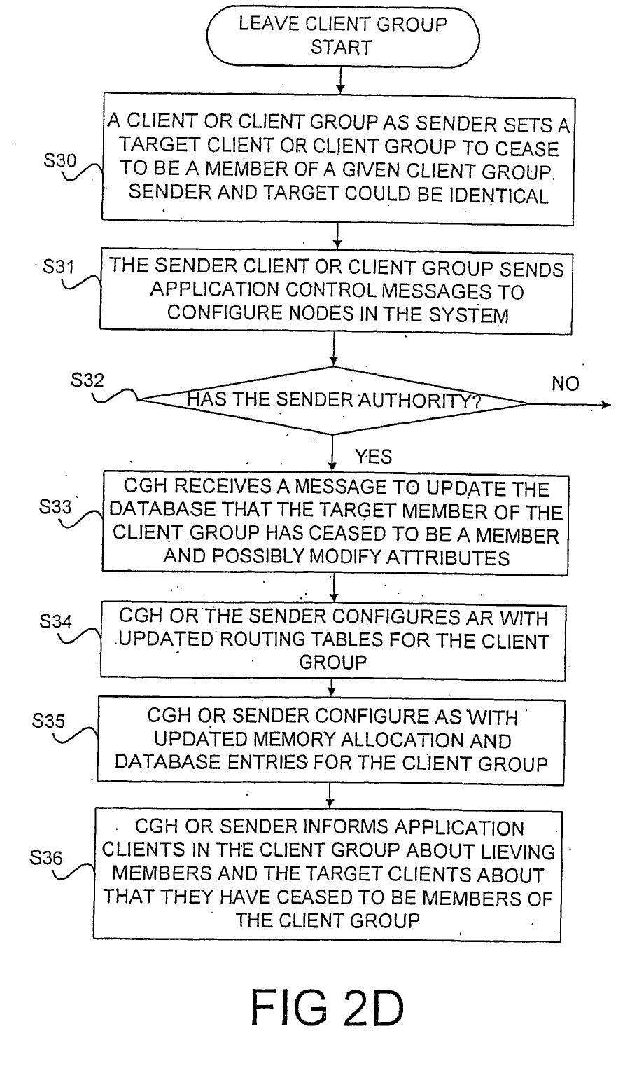

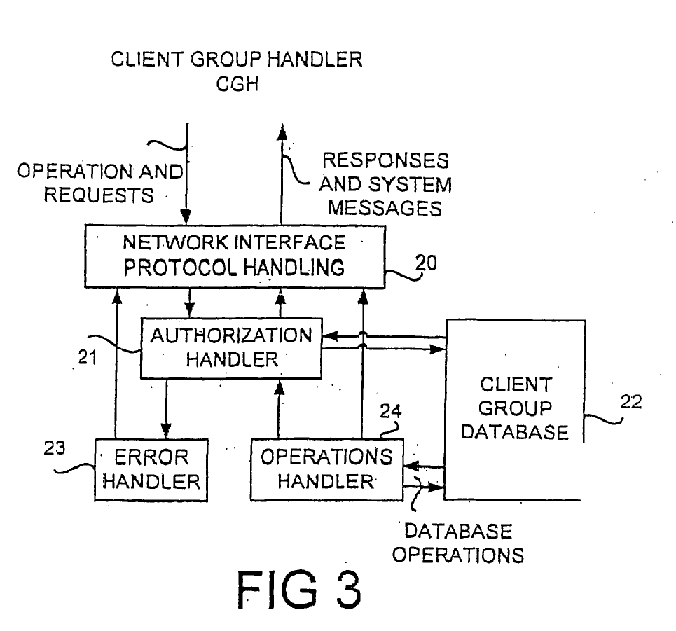

The client group handler CGH supports operations on client groups as described below. Examples of operations are client join and object group create. A detailed description of the client group handler CGH is given below, and illustrated in FIGS. 2A to 2D and FIG. 3. Each client group handler CGH could handle several application sessions 13. A given application session 13 could use several client group handlers CHG. Each client group handler CGH in the session could optionally manage a separate part of the client group database. Several client group handlers CGH could also manage the same database DB1 according to any known method for handling distributed databases.

The client group handler (CGH) has at least two distribution modes for the client groups, of which there are at least one mode called Verbose, where the members get their information, and another is Silent, where at least some members in the client group could get no such information. Thus, there are several verbose modes, in which the members can be provided with different amounts and/or kinds of information, prescribed in the individual verbose modes. One of the verbose-modes could give the client groups all possible information, while another verbose-mode could give the client groups having this verbose-mode could perhaps only get clients joining and clients leaving since those features are of a particular interest. The client group handler CGH stores a name or alternative names of the client group, such that a network address or an application address could identify a client group in order to support operations on client groups.

Application Lobby Server (ALS) (Optional)

The application lobby server ALS is optional and used for setting up the application session. All optional nodes are illustrated with dashed lines. Setting up the application session could also be done in an application router AR or at a client authentication server CAS. The application lobby server could be provided as an external node and thus need not be connected to the programmable application network 1, as marked with a dashed connection.

Participants 5 could register at the application lobby server ALS and negotiate to start an application session. An application service provider 6 might use the application lobby server ALS to authenticate participants and to handle accounting. The application lobby server ALS could set up client groups as a part of the initialization of an application session 13 using for example the session profile 7, see SE- . . . {Profiles}. The application lobby server ALS could optionally specify a client profile 8 for each initiated client group, see SE- . . . {Profiles}.

A session profile 7 consists of a set of application network parameters valid for an application session 13. The session profile is used to initialize and prepare the programmable application network before an application session is started.

A client profile 8 consists of a set of application network parameters valid for a participant in an application session 13. The client profile is used to initialize and prepare the programmable application network and the client computer before a given client joins the application session.

A set of client profiles may be associated to a session profile. Each application is optionally associated to one or several client profiles and application session profiles.

A session profile 7 consisting of a set of application network parameters is prepared and stored before the session 13 starts. The session profile 7 is used to initialize and prepare the programmable application network 1 before a multi-user application is started. A user wishing to initiate an application session 13 negotiates the use of a certain session profile 7 with an application service provider 6. The session profile 7 may include definitions of client groups that should be created as the session 13 is initialized Application Network Management System (ANMS) The application network management system ANMS is used for initializing application sessions that may have been negotiated at an application lobby server ALS. The application network management system ANMS is used for reserving resources, optionally in the communication network 1 and at AS, AR, ACG and ASNS nodes (see below). The application network management system ANMS might also be used for handling error conditions. The application network management system ANMS is using the session profile 7 and the client profile 8 for configuring the programmable application network 1.

Application Client (AC)

An application client AC is a local instance of the computer process that is simulating the networked virtual environment. An application client AC could e.g. be a Windows/UNIX process or thread. One computer process could run one or several application clients AC. An application client AC is thus a logical instance of a game or simulation and is not always identical to any specific computer process, thread, program or machine. The client computers or for example a game console that is running the application client has means for receiving input from the user and displays the output of the application as graphics, video, audio or haptic (physical sensing indication) output. The application client AC may subscribe to, receive and process tagged application data units 9 and send tagged application data units 9.

The session profile 7 and the client profile 8 are used to configure the application client AC so that it communicates according to the session and client profiles 7, 8. The application client AC could be a member of one or several client groups CG. The application client AC could dynamically create and delete client groups. It could also manage the membership and attributes of client groups.

Application Router (AR)

An application router AR is routing application data units 9. The routing is dependent on the application tags (see below) that are carried by each application data unit 9. The participants CG are then connected to the application router through the application client AC and from there to the programmable application network 1. Since client groups could optionally be connected to other nodes, such as ALS and CAS they have got the same reference CG. The application router AR receives data-grams 10 containing application data units 9 from the Communication Network 2. The application router AR reads the application tags of the application data units 9 and resends the application data units 9 across the Communication Network 2 with a network address that depends on the application tags and possibly also on client and client group subscriptions.

Computer memory 3 for routing tables and for client and client group subscriptions and processing resources are reserved for an application session 9 according to the session profile 7 and for an application client or client group according to the client profile 8. An application router AR could optionally multicast to client groups 4 using the application address of the client group as a multicast address.

The application router AR optionally also supports client group operations, such as e.g. “client joining client group”. The application router AR could keep a record of the client group membership of each client. If the application router AR receives a data unit 9 addressed to the client group 4 it could be routed to all members of the client group. The application router AR could also route messages concerning client group operations to the client group handler CGH that has been allocated to manage the client group.

Application Server (AS).

An application server AS stores received application data and stores application data. The application server AS distributes application data to application clients and client groups CG according to queries, requests or subscriptions. Such queries, requests or subscriptions may be expressed in terms of subscriptions to application data units 9 carrying application tags (see below). The computer memory 11 for application data and for subscriptions and processing resources is reserved for an application session 13 according to the session profile 7 and for an application client or a client group according to the client profile 8.

Application Content Generator (ACG)

An application content generator ACG is a server that generates content for an application session 13. It might e.g. be a game server in multi-player games that makes decisions about kills, collisions and damage. It might also be responsible for running avatars that appears to be human-controlled but is managed by artificial intelligence. The application content generator ACG receives and processes application data units 9 and sends application data units 9 carrying application tags. Computer memory 11 for application data and processing resources are reserved for an application session according to the session profile and for an application client according to the client profile. The application content generator ACG could dynamically create and delete client groups. It could also manage the membership and attributes of client groups.

Application Session Name Server (ASNS) (Optional)

The optional application session name server ASNS maps application session names to application tags and vice versa and responds to operations such as setting names, removing names and inquiring about names. It is described in detail in a co-pending application. SE . . . (Fredriks). Computer memory for application databases and processing resources are reserved for an application session 13 according to the session profile 7 and for an application client according to the client profile 8. The application session name server ASNS could keep a database, which relates client group identifiers to each other. The application session name server ASNS could for example have a record for each client group that stores the client group name and application address.

Accounting System (AccS) (Optional)

An optional accounting system AccS could measure the properties of an application session 13 including the start and stop time of the session 13 and the join and leave time of each client. The session profile 7 and the client profile 8 are known by the accounting system AccS and give a description of the network resources that has been used by the session and by each client. The accounting system AccS calculates charges for clients, application service providers and operators according to the business model of the service.

Client group membership could be used for accounting. Client A being a member of client group B might indicate that A is using resources. Client A being a member of client group C might indicate that A is providing a service to the application session 13. A could thus be charged for being a member of B and receive a bonus for being a member of C. The accounting system AS could retrieve data about client group membership from the client group handler CGH.

Client Authentication Server (CAS) (Optional)

Clients could log in at the optional client authentication server CAS before joining an application session 13. The client authentication server CAS may be connected to a user database and reports optionally to the Accounting System AccS. The client authentication server CAS is used to ensure that clients correspond to known users that have a customer account.

Application Profile Database (APDB)

Default session profiles and client profiles are stored in the application profile database APDB. Each type of application (e.g. the computer game Quake III Arena) may have one or several associated session profiles and client profiles in the database APDB. Each session 13 or client profile 7 may have a name, so that they can be retrieved by referring to the name.

Communication Protocols

Network Protocols

The communication network is typically using several packet-based communication protocols, such as IP protocols 10. The communication network 2 carries data-grains in the communication protocols 10 from senders to receivers. A data-gram consists typically of a Header and a Payload. A Header may include one or several network addresses used by Routers in the communication network 2 for sending the data-gram to the receiver. Protocols are often layered so that the payload of one protocol layer may include one or several data-grams of the next protocol layer. Application data units 9 are carried as payload in the network protocol data-grams. The communication network 2 could have a multicast function, e.g. IP multicasting. Client groups could correspond to multicast addresses in the communication network.

Application Transport Protocol

The Application may include its own communication protocol. The data-gram of the application will here be called an application data unit 9. An application data unit 9 consists of a header containing several application tags and a payload. The payload consists of application specific data such as positions, avatar properties, coded voice data etc. The application transport protocol could have a multicast function. Client groups could correspond to application addresses in the application network.

Application Tags

An application tag is a field in packet header or in an application data unit 9 header. It consists hence of a set of bits. An application tag has a type that is marked by the corresponding field's position in the protocol or by flags in the protocol indicating the type of the tag. If an application tag is a field in a general communication protocol it might be a network address, a multicast address or a port number. In the context of a co-pending application PCT/SE00/00932 it is an object identifier, a client identifier, a group identifier or a stream object key. Application tags should be as short as possible for saving network bandwidth. An application address is an application tag that can be used for transmitting data to clients or client groups that are participating in the application.

The application session 13 is typically a simulation of a virtual world. This world includes application items that are meaningful for the human users such as human participants, avatars controlled by humans, avatars controlled by AI, fixed roles in the game that may be switched between users (king, referee . . . ), objects in the virtual world, properties of objects and avatars, groups and teams of avatars, groups of objects, groups of groups, locations in the virtual world, media streams (voice, video) and collections of media streams. All such items may be identified by sets of application tags.

Generic Client Group Operations in the Application Network 1

Client group operations are here described using a pseudo function call. This description does not refer to any computer programming language, library or application program interface API. It is used as a convenient shorthand for referring to operations on client groups in this proposal. The creator, sender, target and receiver parameters in the operations are clients or client groups. Any client or client group identifier including names, aliases and addresses could be used to refer to the client or client group.

Creating a Client Group (FIG. 2A)

Operation: Create_Client_Group (Creator, Identifiers, Attributes, Profile, Owners, Masters)

A client group could be created by e.g. the optional application lobby server ALS when a session 13 is initiated using for example the session profile 7. A client group 5 could also be created by one of the clients or the application content generator ACG during the session, e.g. by using an API. The creator of a client group could optionally specify a name, aliases and address of the client group. Attributes according to the section on “client group attributes” could optionally be defined. A client profile could optionally be set.

A set of owners could optionally be defined. A set of Masters could optionally be defined. Typically the creator would be the owner of the client group. Owners are clients, which have authority to perform certain client group operations on the group, such as Delete_Client_Group. The Masters are clients that have authority to perform certain client group operations related to the Join_Client_Group operation.

S1 Creation of a client group means that the creator is sending one or several application control messages to configure various nodes in the system.

S2, S3 The client group handler CGH could reject the operation if the sender don't have authority to perform the operation, or if system resources are lacking.

S4 The client group handler CGH receives a message, which configures the client group handler CGH so that a new database record is set up for the client group, and the parameters (Identifiers, Attributes, Profile, Owners, Masters) of the operation Create_Client_Group are stored.

S5 Application Routers are configured with routing tables for the client group, either directly by the creator or by the client group handler CGH.

S6 Application Servers' are configured with memory allocation and database entries for the client group either directly by the creator or by the client group handler CGH.

S7 The name database for client groups in the ASNS are configured with entries and Identifiers for the client group either directly by the creator or by the client group handler CGH.

S8 Application clients might be informed about the creation of the client group either directly by the creator or by the client group handler CGH.

Termination Conditions

The termination conditions determine under what circumstances that a client group will be deleted. Possible termination conditions are,

1) termination after a fixed time

2) termination only when the application session is terminated

3) termination as a result of an action by a specific set of authorized clients

4) termination when the number of members is less than N where N is a natural number (1, 2, 3 . . . )

Several termination conditions could be combined.

Below an example of the termination condition 3 is illustrated.

Deleting a Client Group (FIG. 2B)

Operation: Delete_Client_Group (Sender, Target)

S10 The sender is a client or a client group 4. The target is the client group that should be deleted. A client group could be deleted by one of the clients or application content generator ACG during the session e.g. by using an API.

S11 Deletion of a client group means that the sender is sending one or several application control messages to configure various nodes in the system.

S12 The client group handler CGH could reject the operation if the sender don't have authority to perform the operation.

S13 The client group handler CGH receives a message that causes the database entry for the target client group to be removed.

S14 The client group handler CGH notifies the members and owners of the group that the group has been deleted.

S15 AR, AS, ASNS are notified that the client group is deleted either directly by the sender or by the client group handler CGH.

Join (FIG. 2C)

Operation: Join_Client_Group (Sender, Target, Group, Optional Parameters)

S20 A sender that could be a client or a client group performs the Join_Client_Group operation. The target is a client or a client group that should become a member of the Group. The sender could be identical to the target.

S21 Join_Client_Group means that the Sender is sending one or several application control messages to configure various nodes in the system.

S22 The client group handler CGH could reject the operation if the sender does not have authority to perform the operation or if system resources are lacking.

S23 The client group handler CGH receives a message that configures the client group handler CGH so that the database is updated with the new members of the group. The attributes of the group might be modified according to the optional parameters.

S24 The Application Routers AR are configured with updated routing tables for the client group either directly by the creator or by the client group handler CGH.

S25 The Application Servers AS are configured with updated memory allocation and database entries for the client group either directly by the creator or by the client group handler CGH.

S26 Application clients might be informed about the new members of the client group either directly by the sender or by the client group handler CGH. The Target clients should in particular be informed that they have become members of the group. The sender should receive a message from the client group handler CGH indicating that the operation was successful or failed.

The Join_Client_Group is handled differently depending on the client group protection mode.

Open Protection Mode

The join request is accepted immediately as described above

Closed Protection Mode

The client group handler CGH will ensure that the join request is authorized. There are several methods for ensuring this.

1) Invite method. An authorized client A issues an invitation for a client B to join the client group C. The client group handler CGH database DB1 lists authorized clients explicitly or implicitly. The group of authorized clients is called the master group. Authorized clients could e.g. be the owners of the client group or any member of the client group. The client group handler CGH gets a message saying that client B has been invited. The message might include a timeout T indicating that the client group handler CGH should keep the client B in the list of invited client for a time T. The Client B gets a message from the client A or from the client group handler CGH indicating that the client B is invited to join the client group. Client B can now join the client group by using the Join Client Group operation. The client group handler CGH will accept the join operation if client B is in the list of invited clients for the client group. The invite method requires a new operation:

Operation: Invite_To_Client_Group (Sender, Target, Group, optional Parameters)

Where the target is the client or client group that issues the invitation and the target is the client or client that is invited to join the group.

A special case of the invite method is when a client that wishes to join a protected client group requests an invitation from a member of the master group. The receiver of the request decides if an invitation is sent.

2) Request method. A client B that wishes to join a client group C issues a request to join the group to the master group for the client group C. The request might be sent directly from B to one or several members of the master group. The request could also be sent to the client group handler CGH. The client group handler CGH forwards the request to one or several members of the master group. A member of the master group responds by either rejecting or approving the request. The approval or rejection is sent as a message to the client group handler CGH. If the request is approved the client group handler CGH will do the same operation as for a successful Join_Client_Group operation. Client A will be notified that the request has been approved or rejected. The request method requires three new operations:

Operation: Request_Join_Client_Group (Sender, optional Target, Group, Optional Parameters)

Operation: Approve_Join_Client Group (Sender, Target, Group, Optional Parameters)

Operation: Reject_Join_Client_Group (Sender, Target, Group, Optional Parameters)

3) Force method. An authorized client A calls the Join_Client_Group operation causing a client B to join the client group C. The client group handler CGH database DB1 lists authorized clients explicitly or implicitly.

Authorized clients could be for example content servers in the application session 13. The Join_Client_Group is processed as described above. Clients that join according to the force method are optionally not allowed to leave without the permission of an authorized client.

Leave (FIG. 2D)

Operation: Leave_Client_Group (Sender, Target, Group, Optional Parameters)

S30 A sender that could be a client or a client group performs the Leave_Client Group operation. The target is a client or a client group that should cease to be a member of the Group. The sender could be identical to the target.

S31 Leave_Client_Group means that the Sender is sending one or several application control messages to configure various nodes in the system.

S32 The client group handler CGH could reject the operation if the sender does not have authority to perform the operation.

S33 The client group handler CGH receives a message that configures the client group handler CGH so that the database is updated. The attributes of the group might be modified according to the optional parameters.

S34 Application Routers are configured with updated routing tables for the client group either directly by the creator or by the client group handler CGH.

S35 Application Servers are configured with updated memory allocation and database entries for the client group either directly by the creator or by the client group handler CGH.

S36 Application clients might be informed about the leaving members either directly by the sender or by the client group handler CGH. The Target clients should in particular be informed that they have ceased to be members of the group. The sender should receive a message from the client group handler CGH indicating that the operation was successful or failed.

The client group handler CGH could optionally check if the sender is authorized to let the target leave the group. The client group handler CGH rejects unauthorized leave operations.

Subscribe

Operation: Subscribe_To_Data (Subscriber, Receiver, Data Descriptors, Parameters)

The subscriber is a client or client group that issues the subscription. The Receiver is a client or client group. The members of the client group receive the result of the subscription. The data descriptors specify the application data that will be delivered to the client group. Data descriptors are typically application tags or names of data units that can be translated to application tags using e.g. the application session name server ASNS. The parameters are further detailing the priority, frequency of update or time-out of the subscription.

The operation means that the subscriber is sending one or several application control messages to configure various nodes in the system.

The client group handler CGH receives an optional message that includes the subscription in the CGH database.

The Application Routers AR are optionally configured with routing tables indicating that the members of the client group should receive the data units that are indicated in the subscription according to the parameters of the subscription.

Routers in the communication network (e.g. IP routers) could possibly be configured with routing data indicating that the members of the client group are members of an IP multicast group, to which data units addressed to the specified client group are distributed.

The Application Servers AS are optionally configured with subscription tables indicating that the members of the client group should receive the data units that are indicated in the subscription according to the parameters of the subscription.

The Clients and the application content generator ACG are optionally configured with subscription tables indicating that the members of the client group should receive the data units that are indicated in the subscription according to the parameters of the subscription.

Create Data Unit Belonging to a Client Group

Operation: Create_Data_Unit (Creator, Data Unit Identifier, Parameters)

The creator is a client or client group that will be the source of the data unit. The Application network units such as As, AR and ASNS might register the client group as the owner of the data unit. The data unit identifier is usually a name or alias that identifies the data unit. The parameters are further detailing the priority, security class, network service etc.

The operation means that the creator is sending one or several application control messages to configure various nodes in the system.

The client group handler CGH receives an optional message. The client group might be registered as the owner of the data unit in the CGH database DB1. The client group handler CGH might return a data unit identifier or a tag value that should be used to identify the object.

The Application Routers AR are optionally configured with tables indicating that the members of the client group is entitled to send the data unit according to the parameters. The creator or the client group handler CGH might send this message.

Routers in the communication network (e.g. IP routers) could possibly be configured with routing data indicating that the members of the client group are sources of an IP multicast group.

The Application Routers AS are optionally configured with tables indicating that the members of the client group is entitled to send the data unit according to the parameters. The creator or the client group handler CGH might send this message.

Clients and the application content generator ACG are optionally configured with tables indicating that the client group is the source of the data unit.

Send Data Units

Operation: Send_Data (Sender, Receiver, Data unit Descriptors, Payload, Parameters)

The sender is a client or client group that is the source of the data unit. The sender might have created the data unit using the Create_Data_Unit operation. The optional Receiver is a client, a client group or an application network node such as an application router AR or an application server AS. The receiver gets a copy of the data unit. The data unit descriptors specify the data unit header including the tags. The payload is application data, which will be transported. The parameters are further detailing the priority, security class, network service etc.

The operation means that the sender is sending one or several data units to various nodes in the system.

The Application Routers AR are routing the data unit according to the receiver address and any subscriptions.

Routers in the communication network (e.g. IP routers) are optionally routing the data unit according to the IP addressing.

The Application Servers AS are optionally storing the data unit according to the parameters and are also'forwarding the data unit according to the subscriptions.

Clients and the application content generator ACG are optionally receiving the data unit according to the receiver address and their subscriptions.

Disconnect Members

Operation: Disconnect_Members (Sender, Target, Parameters)

The sender is a client or client group. The target is a client group. The parameters are further detailing the conditions of the operation.

The operation means that the sender is sending one or several application control messages to configure various nodes in the system.

The application network management system ANMS receives a request for disconnecting the members of the client group from the session. It checks if the operation and the sender is authorized and disconnects the members of the client group or sends an error message back to the sender. Disconnection might involve a negotiation between the application lobby server ALS and the application network management system ANMS.

Disconnection means usually that all concerned nodes in the application network are notified that a client has disconnected.

Send Message to Members

Operation: Send_Message (Sender, Receiver, Parameters)

The sender is a client or client group, which is the source of message. The receiver is a client or client group. All members of the receiver get a copy of the message. The sender is not required to know the member list of the client group.

The parameters are further detailing the priority, security class, network service etc.

The operation means that the sender is sending one or several data units to various nodes in the system.

The Application Routers AR are routing the data unit according to the receiver address.

Routers in the communication network 2 (e.g. IP routers) are optionally routing the data unit according to the IP addressing.

Clients and the application content generator ACG are optionally receiving the data unit according to the receiver address.

Get Information About a Client Group

Operation: Get_Client_Group Information (Sender, Target, Parameters)

The sender is a client or client group that requires information about the target. The target is a client group. The parameters are further detailing requested information.

The operation means that the sender is sending one or several data units to various nodes in the system.

A) the client group handler CGH responds optionally to the query by sending appropriate entries from the client group database DB1 to the sender.

The application session name server ASNS responds to questions about client group identifiers according to Ref. SE- . . . {Name Server}

B) Members of the client group responds optionally e.g. by confirming their membership.

Special Client Group Operations in the Application Network 1

Setting the Membership Protection Mode

Operation: Membership protection mode (Sender, Target, Master, Parameters)

The sender is a client or a client group. The target is a client group. Master is a client or client group. The parameters detail the choice of protection mode. Typically there is one parameter that describes the selected mode e.g. open or closed.

The operation means that the sender is sending one or several data units to various nodes in the system.

The client group handler CGH responds to the operation by setting the appropriate attribute in the client group database. The Master is added to the master group of the client group.

Setting the Event Distribution Mode

Operation: Event Distribution Mode (Sender, Target, Parameters)

The sender is a client or a client group. The target is a client group. The parameters detail the choice of event distribution mode. Typically there is one parameter that describes the selected mode e.g. verbose or silent.

The operation means that the sender is sending one or several data units to various nodes in the system.

The client group handler CGH responds to the operation by setting the appropriate attribute in the client group database. Messages about modifications in the client group state, such as joining or leaving members, are sent according to the event distribution mode.

Name and Alias Operations

The application session name server ASNS responds to name operations for client groups as described in ref SE- . . . {Name Server}. The name server for client groups could optionally be merged with the client group handler CGH.

Setting Termination Conditions

Operation: Termination Conditions (Sender, Target, Parameters)

The sender is a client or a client group. The target is a client group. The parameters detail the choice of termination conditions.

The termination conditions for a client group could optionally be set in the client profile 8. The termination conditions could also be set dynamically by an operation that is sending a message to the client group handler CGH requesting that a new termination condition is set. The client group handler CGH responds by either accepting or rejecting the request depending on if the requesting client is authorized. The operation means that the sender is sending one or several data units to various nodes in the system.

The client group handler CGH will now monitor if the termination condition is satisfied. If the termination condition is satisfied the client group will be removed according to the Delete_Client_Group operation.

Membership Information

Operation: GetParents (Target)

Operation: GetChildren (Group)

A client or client group could use the operations to request information about a client group from the client group handler CGH. The CGH responds by sending a list of all client groups where the target is a member and a list of all members of the group.

Operations Relating to Hierarchical Client Groups

The Join_Client_Group and Leave_Client_Group operations could support building client group hierarchies. The client group handler CGH could optionally accept that a client group joins a client group. As a special case it could only be allowed that clients joins client groups. If hierarchical client groups are allowed, the client group handler CGH could respond to the following queries:

Operation: GetAncestors (Target)

The client group handler CGH returns a list of all ancestors of the target.

Operation: GetDescendants (Target)

The client group handler CGH returns a list of all descendants of the target.

Super Clients

A special solution for handling authorization to perform client group operations is to designate certain clients as super clients. This could be done via a “client status” parameter in the client profile or alternatively via an API command. The client group handler CGH could optionally keep a record on the client status. The application router AR could optionally keep a record on the client status and make sure that the client status is correctly flagged in client group operation messages.

Super clients would have the right to perform all client group operations on any group. They could thus be assumed to be the owners and masters of all client groups.

Client Group All

An application network could optionally always have a default client group that includes all clients in the session.

Details of the Client Group Handler CGH

The client group handler CGH communicates with Clients, the ACG, AR, AS during the session. The application network management system ANMS and optionally the application lobby server ALS could configure the client group handler CGH when a session is initialized. The ANMS could e.g. process the session profile and appropriate client profiles and set up initial client groups in the client group handler CGH using the client group operations that is described above.

Architecture Embodiment

FIG. 3 shows an embodiment of a client group handler CGH. Data-grams containing operations and requesting coding according to the application transport protocol (e.g. GTP in ref PCT/SE00/00932) and possibly carried by a communication protocol (e.g. TCPI/IP) are received by the Network Interface and Protocol Handler 20. This unit 20 sends the client group handler CGH operations (see above) to the Authorization Handler 21. The Authorization Handler checks if the operation is allowed using information from the Client Group Database CGDB 22. Rejected operations are sent to the Error Handler 23. The Error Handler 23 sends notifications about the error to the appropriate clients and client groups, as described above. Authorized operations are sent from the Authorization Handler 21 to the Operations Handler 24. This unit 24 is processing the client group operations, as described in this document. Data about the members and attributes of client groups are recovered from the Client Group Database 22 as needed. The content of the Client Group Database 22 may be modified as a result of the operations as described in this document.

Client Group Database (CGDB) 22

The client group database CGDB contains one session database for each session 13. In the session database there is one client group entry for each client group. The client group entry could consist of the following fields,

1) Client group identifiers.

2) A list of members.

3) An optional list of parents.

4) An optional list of ancestors.

5) An optional list of descendants.

6) An optional list of owners.

7) An optional list of masters.

8) A list of optional attributes according to the section “client group attributes”.

Lists of clients and client groups in the client group entry could have flags showing if a listed item is a client or a client group. The list could use any client and client group identifier format.

Examples of Advantageous Use of the Invention

Effective Multicasting of Application Data

Consider a voice chat application where the virtual world consists of a many meeting rooms. Users control avatars and select a meeting room of their choice where the avatar stays. Users speak in a microphone causing the corresponding application client to send a voice channel over the application network.

All clients that enter a meeting room join a client group that corresponds to the meeting room. The client group identifier is a multicast address in the application transport protocol. Clients send each voice packet with an application tag that is the client group identifier. The Application routers are configured to multicast all data units that carries a client group identifier to the members of the client group. This means that the voice channels will be effectively multicast to the clients that are in the same virtual meeting room.

Security Enabling Private Communication

A group of users wish to use a meeting room in the virtual world for a private meeting. Any newcomer should not be able to listen to the conversation in the meeting room without being invited. The application provides a set of private meeting rooms that are available on request for private meetings. One client is the chat manager and allocates private meeting rooms on request.

A private meeting room corresponds to a client group with protection mode closed. An empty room has the chat manager as the only member of the master group of the client group. A group of clients decides that the group members want to use a private room. They elect a chairman. The chairman asks the chat manager for a private room. The chat manager selects an empty private room and invites the chairman to the master group. The chairman joins and invites the other members of the group. All members join. They are now all in the private room and enjoy a secret conversation. A new client enters the room. He can see the other clients but he can not listen to the conversation, because he is not a member of the client group that corresponds to the private meeting room. It is not possible for the new client to join the closed client group directly. The new client could ask the chairman for an invitation to join the group. If the chairman decides to invite, the new client could join the group.

Managing Persistent Roles in a Persistent Multiplayer Game

The virtual world in a large multi-player game consists of several countries. Each country has one general that is in charge of the army. The army consists of players that presently are playing the game as soldiers. The general is always needed for making military decisions and for managing a set of critical objects in the virtual world including a treasure chest, a magic sword and the key to the dragon caves. The game goes on day and night but no human player could play the general all the time. The role of the general must be shifted between several players.

The general is represented by a special client group (a pseudo client), which is a source (owner) of game data and has exactly one member at any given time. The central content server is always included in the master group of the “general” and the client playing the role of the general is a member of the master group and the single member of the client group. Being the single member of the client group he can manage the objects that are owned by the “general”. He can take money from the treasure, wield the magic sword and even open the door to the cave of the dragons. When the player leaves the game he leaves the client group “general”. The content server or the departing player could invite a new player to take the role of the general.

Managing Shared Application Data

Four players are flying fighters in simulated air war. They are all in the same team. The simulation includes a WW II radio communication system where all players use the same channel simultaneously for screaming things like “Bandits at four o'clock!!!”.

The four players forms a client group that owns a multicast “channel” e.g. a stream object according to Ref. PCT/SE00/00932. The collectively owned channel consists of data units with a specific tag that identifies the channel. Any member of the client group can send on the channel at any time And they subscribes all to the channel. Voice mixing is performed locally in each player machine.

Distributing Information About the State of the Members of a Client Group

A virtual expo consists of a simulated exhibition hall where companies show their products in stands. Visitors walk around and enter stands that they are interested in. Humans working for the different companies get an alarm on their cell phones as soon as someone enters their stand. A representative of a company will then appear as an avatar at the stand and meet the customer.

Each stand is a client group. A visitor that enters the stand becomes a member of the client group. A computer application in the cell phone subscribes to the state of the client group. The client group handler CGH sends a message to the cell phone every time the number of members goes from zero to a positive number. This message triggers an alarm in the cell phone.

One skilled in the art will appreciate that the present invention is not limited to the embodiments disclosed in the accompanying drawings and the foregoing detailed description, which are presented for purposes of illustration only, but it can be implemented in a number of ways, and it is defined by the following claims.

Appendix

### A Brief Description of IP Multicasting

IP multicasting is a method for distributing data to multiple users on a network. Data is delivered only to a selected group of users called the host group. This group is defined by a multicast address. The source sends one copy of the data to the multicast address. The network takes care of duplicating the data as needed and to deliver it to all users in the host group. Network resources are conserved since data is copied only at branch points where it is strictly required. Multicasting is hence economical and scalable.

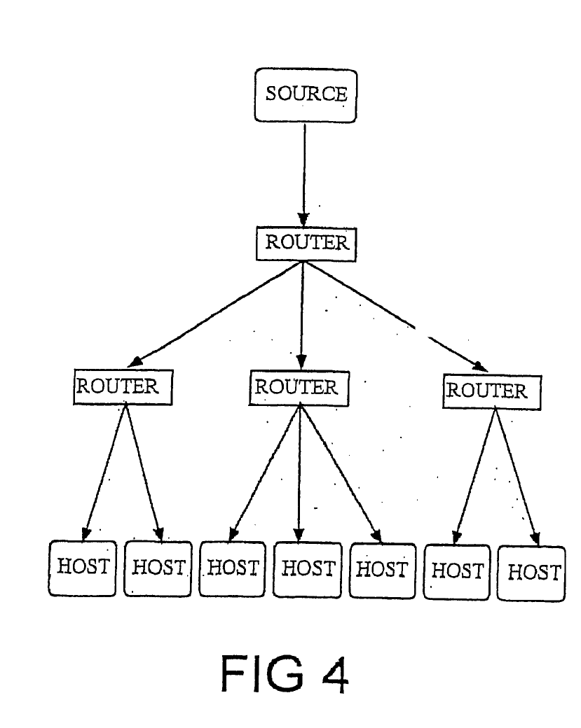

Uni-casting, where the source sends one copy of the data to each user, wastes network bandwidth and server resources. Broadcasting makes each host receive the data even if it is intended only for a small group. The concept of IP multicasting is shown in FIG. 4.

ISP's have been reluctant to deploy multicasting because of difficulties in controlling and charging for the use of network resources. One multicast packet, which enters from one ISP domain to another, might give rise to an explosion of traffic as the packet is duplicated at downstream branches. Such explosions can not be predicted since there is no central node that keeps' track of the host group. End users that are charged a flat rate does not pay extra for receiving multicast traffic. Deploying IP multicasting will hence be much easier if the network usage of each subscriber can be monitored.

1. A communication infrastructure arrangement in a data processing system for multi-user applications, i.e. applications for multiple clients, enabling simultaneous communication across an application communication network (1) between several clients joined in at least one client group (CG), said infrastructure arrangement comprising:
a) at least one distributed multi-user application on the application communication network (1), each multi-user application having nodes (AC, ASNS, ACG, AR, AS, APDB, ALS, ANMS, CAS, CGH) and databases (11, DB1, APDB) for handling each client group (CG);
b) a set of attributes (7, 8, CGDB) for each client group (CG) determining the function and usage of the client group, at least one of said attributes being selected among the following: Receiver, Source, Membership protection mode, Event distribution mode, Name and Alias, Distribution mode, Termination conditions, Client profile, Parents, Ancestors, Children, Descendants;
c) at least one session (13), in which the attributes are listed;
d) the selection of attributes being made to fit the intended function of the client group (CG) and the capabilities of the application communication network (1), said infrastructure arrangement being characterized in that it further comprises:
e) a receiver client group for distributing identical data to all members of the client group, the receiver client group having an associated network address (e.g. an IP multicast) or an application address; and an application server (AS) for distributing the application data to application clients and client groups (CG) according to queries, requests or subscriptions, such queries, requests or subscriptions may be expressed in terms of subscriptions to application data units (9) carrying application tags.

2. A communication infrastructure arrangement according to claim 1, characterized in that each attribute is set independently of the other attributes.

3. A communication infrastructure arrangement according to claim 1 or 2, characterized in that the client group address is either a network addressor an application address, and a sender knowing the client group address transmits data to all members of the group.

4. A communication infrastructure arrangement according to any one of the preceding claims, characterized by a source client group being the owner or the source of application data units, the source client group acting as a sender of the data unit.

5. A communication infrastructure arrangement according to claim 4, characterized by a pseudo client being a source client group having at least one active member using the client group as an alias, e.g. for providing a persistent service to the session.

6. A communication infrastructure arrangement according to any one of the preceding claims, characterized in that some clients are authorized clients and have particular rights, the authorized client group being called the master group, unauthorized clients have prescribed limitations regarding operations to perform.

7. A communication infrastructure arrangement according to claim 6, characterized by a security system where only authorized clients are accepted as members to protect the right to become a member and/or to leave of a client group.

8. A communication infrastructure arrangement according to claim 6 or 7, characterized in the authorized clients are the owners of the client group or any member of the client group.

9. A communication infrastructure arrangement according to any one of the claims 6 to 8, characterized in that the security systems have at least two membership protection modes, of which one is secure to be closed for non-authorized clients and open only for authorized clients and the other is free for all clients to join and leave, as they like.

10. A communication infrastructure arrangement according to any one of the preceding claims, characterized by a client group handler (CGH) providing information to the members of the client group (CG) about group events, such as clients joining, clients leaving, data units created and deleted, data subscriptions etc.

11. A communication infrastructure arrangement according to claim 10, characterized in that the client group handler (CGH) has at least two distribution modes, of which there are at least one called Verbose, where the members get their information, and another is Silent, where at least some members in the client group could get no such information.

12. A communication infrastructure arrangement according to claim 11, characterized in that there are several verbose modes, in which the members can be provided with different amounts and/or kinds of information, prescribed in the individual verbose modes.

13. A communication infrastructure arrangement according to anyone of the claims 10 to 12, characterized in that the client group handler (CGH) stores a name or alternative names of the client group, such that a network address or an application address could identify a client group in order to support operations on client groups.

14. A communication infrastructure arrangement according to any one of the preceding claims, characterized by application tags serving as client group identifier means for identifying the client group.

15. A communication infrastructure arrangement according to any one of the preceding claims, characterized by an application server (AS) distributing application data to application clients and client groups (CG) according to queries, requests or subscriptions.

16. A communication infrastructure arrangement according to claim 14 or 15, characterized in that the queries, requests or subscriptions are expressed in terms of subscriptions to application data units (9) carrying application tags.

17. A communication infrastructure arrangement according to any one of the claims 10 to 16, characterized in that the client group handler (CGH) comprises a database (DB1) containing data about client groups, the data including for each client group the list of members, and, a list of the attributes of the client group.

18. A communication infrastructure arrangement according to claim 17, characterized in that the database (DB 1) also comprises a list of invited members, and a list of client group owners.

19. A communication infrastructure arrangement according to any one of the preceding claims, chracterized in that a network address or an application address identifies a client group, a client group has also a name that is known by the application and stored in an application session name server (ASNS) or in the client group handler (CGH).

20. A communication infrastructure arrangement according to any one of the preceding claims, characterized in that at least one of the client groups also has one or several alternative names called aliases.

21. A computer readable program product comprising a computer useable medium having computer readable code embodied therein for causing a computer to store an unpredictable amount of time-valued or log data in a file system of a computer operating system executing an application program, said computer readable code comprising:
computer readable program and code devices configured to cause a device with computational capacity to install a software environment and user interface for management of software components for providing communication infrastructure in a data processing system for multi-user applications, i.e. applications for 1 multiple clients, enabling simultaneous communication across an application communication network (1) between several clients joined in at least one client group (CG), comprising
a) computer readable programs and code devices configured to cause at least one distributed multi-user application on the application communication network (1), each multi-user application having nodes (AC, ASNS, ACG, AR, AS, APDB, ALS, ANMS, CAS, CGH) and databases (11, DB1, APDB) for handling each client group (CG);
b) computer readable programs and code devices configured to cause a set of attributes (7, 8, CGDB) for each client group (CG) determining the function and usage of the client group, at least one of the attributes being selected among the following: Receiver, Source, Membership protection mode, Event distribution mode, Name and Alias, Distribution mode, Termination conditions, Client profile, Parents, Ancestors, Children, Descendants;
c) computer readable programs and code devices configured to cause at least one session (13), in which the attributes are listed;
d) the selection of attributes being made to fit the intended function of the client group (CG) and the capabilities of the application communication network (1), said computer program product being characterized by:
e) computer readable programs and code devices configured to cause a receiver client group for distributing identical data to all members of the client group, the receiver client group having an associated network address (e.g. an IP multicast) or an application address; and
f) computer readable programs and code devices configured to cause an application server (AS) for distributing the application data to application clients and client groups (CG) according to queries, requests or subscriptions, such queries, requests or subscriptions may be expressed in terms of subscriptions to application data units (9) carrying application tags.

22. A computer readable program product according to claim 21, characterized in that each attribute is set independently of the other attributes.

23. A computer readable program product according to claim 22, characterized in that the client group address is either a network address or an application address, and a sender knowing the client group address transmits data to all members of the group.

24. A computer readable program product according to any one of the claims 21 to 23, characterized by computer readable programs and code devices configured to cause a source client group being the owner or the source of application data units, the source client group acting as a sender of the data unit.

25. A computer readable program product according to claim 24, characterized by computer readable programs and code devices configured to cause a pseudo client being a source client group having at least one active member using the client group as an alias, e.g. for providing a persistent service to the session.

26. A computer readable program product according to anyone of the claims 21 to 25, characterized in that some clients are authorized clients and have particular rights, the authorized client group being called the master group, un-authorized clients have prescribed limitations regarding operations to perform.

27. A computer readable program product according to claim 26, characterized by computer readable programs and code devices configured to cause a security system where only authorized clients are accepted as members to protect the right to become a member and/or to leave of a client group.

28. A computer readable program product according to claim 26 or 27, characterized in that the authorized clients are the owners of the client group or any member of the client group.

29. A computer readable program product according to anyone of the claims 26 to 28, characterized in that
the security systems have at least two membership protection modes, of which one is secure to be closed for non-authorized clients and open only for authorized clients and the other is free for all clients to join and leave, as they like.

30. A computer readable program product according to anyone of the claims 21 to 29, characterized by computer readable programs and code devices configured to cause a client group handler (CGH) providing information to the members of the client group (CG) about group events, such as clients joining, clients leaving, data units created and deleted, data subscriptions etc.

31. A computer readable program product according to claim 30, characterized in that the client group handler (CGH) has at least two distribution modes, of which there are at least one called Verbose, where the members get their information, and another is Silent, where at least some members in the client group could get no such information.

32. A computer readable program product according to claim 31, characterized in that there are several verbose modes, in which the members can be provided with different amounts and/or kinds of information, prescribed in the individual verbose modes.

33. A computer readable program product according to anyone of the claims 29 to 32, characterized in that the client group handler (CGH) stores a name or alternative names of the client group, such that a network address or an application address could identify a client group in order to support operations on client groups.

34. A computer readable program product according to anyone of the claims 21 to 33, characterized by computer readable programs and code devices configured to cause application tags serving as client group identifier means for identifying the client group.

35. A computer readable program product according to anyone of the claims 21 to 34, characterized by computer readable programs and code devices configured to cause an application server (AS) distributing application data to application clients and client groups (CG) according to queries, requests or subscriptions.

36. A computer readable program product according to the claims 33 and 35, characterized in that the queries, requests or subscriptions are expressed in terms of subscriptions to application data units (9) carrying application tags.

37. A computer readable program product according to anyone of the claims 30 to 36, characterized in that the client group handler (CGH) comprises a database (DB1) containing data about client groups, the data including for each client group the list of members, and, a list of the attributes of the client group.

38. A computer readable program product according to claim 37, characterized in that the database (DB1) also comprises a list of invited members and a list of client group owners.

39. A computer readable program product according to anyone of the claims 21 to 38, chracterized in that a network address or an application address identifies a client group, a client group has also a name that is known by the application and stored in an application session name server (ASNS) or in the client group handler (CGH).

40. A computer readable program product according to anyone of the claims 21 to 39, characterized in that at least one of the client groups also has one or several alternative names called aliases.
